(19) United States
(12) Patent Application Publication
(10) Pub. No.: US 2007/0266625 A1
(43) Pub. Date: Nov. 22, 2007

(54) Plant cover

(76) Inventors: Beverly L. Markis, Minneapolis, MN (US); James P. Palmquist, Minneapolis, MN (US)

Correspondence Address: Curtis D. Kinghorn;Sirius Strategic, LLC, 6769 W. Shadow Lake Dr., Lino Lakes, MN, 55014, US

(21) Appl. No.: 11/435,255

(22) Filed: May 16, 2006

(51) Int. Cl. A01G 13/02

(52) U.S. Cl. 47/31; 47/29.6

(57) ABSTRACT

A plant cover is disclosed that is removably placed over a garden or garden area to prevent access to the garden or garden area by animal or insect pests. The plant cover includes a wire or mesh screen main body having holes of a sufficient size to prevent the undesired animal pest from being able to pass through the holes in the screen. The main body is open on the bottom and sits over the garden or area of the garden to be protected. The plant cover also has a pair of opposed end pieces that are attached to and provide structural support for the main body. The plant cover may also include a handle to allow the plant cover to be easily lifted off of the garden. Ideally, the plant cover, including all its parts and pieces, may fold into a compact unit for storage or transportation and then be unrolled and joined together to make the final plant cover that is useful to protect the garden or garden area.

### BACKGROUND OF THE INVENTION

1. Field of the Invention

The present invention is directed to devices and methods for protecting a garden or garden area from animal or insect pests.

2. Description of Related Art

The National Gardening Association (NGA) estimates that 85 million households in America (79 percent) participate in one or more indoor or outdoor gardening activity annually. They estimate that thirty six percent (36%) of American households (about 39 million) have a flower garden while twenty two percent (22%) (about 24 million) have a vegetable garden. Demographically, the biggest consumers of lawn and garden products, an indicator or gardening activity, are middle-aged, affluent homeowners. In particular, the NGA estimates that the largest groups of lawn and garden product consumers are men, people 35-44 years of age or 55 and older, college graduates, households in the Northeast, South and West, married households, 2-person households and households with annual incomes over $75,000. Further, the single biggest spender on lawn and garden products are homeowners in the 55- to 64-year-old age group.

Today the average homeowner is 52 years old. But, as the baby boomers currently in the 38 to 56 year old group, particularly homeowners in this group, age into the 55- to 64-year-old group, it is believed that spending on plants and flowers will increase dramaticaly.

It is believed that demographic shifts in the American population, particularly the aging of the population combined with rising income and increased home ownership, is behind this high level of gardening. In addition, some observers of this explosion of gardening have speculated that the real driver for growth in gardening is consumers' passion to reconnect with the natural world. Regardless of the motivation of gardeners, it is clear that there is a large interest in gardening.

There are a number of animals commonly found in the urban, suburban and rural settings that can become pests with respect to these gardens. Such common animals as squirrels, chipmunks, raccoons, rabbits, deer and even dogs and cats, including the gardener's own dog or cat, can tear up turf and flowerbeds and eat plants in gardens. Further, some communities have more exotic animal pests in the form of skunks, armadillos, foxes, ground hogs and other herbivores and omnivores and insect pests such as grasshoppers and locusts.

It is highly desirable to most gardeners to prevent damage to their gardens from such animal or insect pests. Consequently, means and devices have been developed to prevent such damage by these pests. Some of the more extreme of these techniques, such as using firearms, traps or poisons against the animal pests are generally socially frowned upon or prohibited especially in urban or suburban areas. Further, many animal pests are protected by law.

As a result, techniques have evolved that either prevent the animal or insect pests from having access to the gardens or deter the pests from desiring to approach or remain in the garden. For example, many gardeners surround their gardens with a fence. To keep small animals out of the garden, many garden fences are made of a wire mesh such as chicken wire or hardware cloth.

Sometimes these fences have electrified strands. However, many gardeners do not want or for practical reasons cannot put up such electrified fences. In addition, many gardeners do not want to expose their children, pets or non-pest animals to the effects of contact with an electrified fence. Typically, these fences, whether electrified or not, are open at the top. As a result, many animals are able to jump or climb over the fence to gain access to the garden with the undesired effect.

A variant of the fence has been developed in the form of a plant cage. Plant cages are cages of wire, mesh or screen that surround particular plants and prevent pest animals from having contact with the plant being protected.

Another approach to keeping pest animals from having contact with garden plants is the use of repellants. Repellants typically release a scent, which makes the animal or insect pest uncomfortable and thereby keeps them away from the treated areas. Some repellants taste terrible. Once a pest gets a taste of the repellant on a plant, they will not chew the plant again. However, there is considerable variability with repellents particularly depending on location, timing and the particular animal or insect pest. For example, if the pests are not very hungry or population pressures are not too great, repellents may be enough to discourage these unwanted invaders. Also, many of these repellants require periodic renewal with the associated expense and trouble.

In view of the foregoing, it can be seen that there is a need for a device that overcomes the problems and limitations set out above. In particular, there is a need for a simple and easy to use device that protects a garden or garden area from animal or insect pests.

### SUMMARY OF THE INVENTION

The present invention is a plant cover that is removably placed over a garden or garden area to prevent access to the garden or garden area by animal or insect pests. The plant cover includes a wire or mesh screen main body having holes of a sufficient size to prevent the undesired animal pest from being able to pass through the holes in the screen. The main body is open on the bottom and sits over the garden or area of the garden to be protected. The plant cover also has a pair of opposed end pieces that are attached to and provide structural support for the main body. The plant cover may also include a handle to allow the plant cover to be easily lifted off of the garden. Ideally, the plant cover, including all its parts and pieces, may fold into a compact unit for storage or transportation and then be unrolled and joined together to make the final plant cover that is useful to protect the garden or garden area.

There are many objects of the present invention that may be addressed individually or in combinations and permutations in the various embodiments of the invention. Consequently, a particular embodiment of the invention may address one or more of the following objectives.

It is therefore an object of the invention in one embodiment to make a plant cover that protects a garden or garden area from animal or insect pests.

It is an object of the invention in an embodiment of the invention to provide a plant cover that is easily stored or transported.

It is an object of the invention in an embodiment of the invention that may be easily lifted off of the garden or garden area to allow access to the garden or garden area by the gardener.

It is a further object of the invention in an embodiment of the invention to provide a plant cover that is relatively inexpensive to manufacture.

It is another object of the invention in an embodiment of the invention to provide a plant cover that is useful in protecting plants and garden or garden area from a variety of animal or insect pests.

It is a further object of the invention in an embodiment of the invention to provide a plant cover that is relatively simple to assemble.

It is a further object of the invention in an embodiment of the invention to provide a plant cover that a strong yet lightweight.

It is a further object of the invention in an embodiment of the invention to provide a plant cover that is reusable from year to year.

It is a further object of the invention in an embodiment of the invention to provide a plant cover that is disposable after a season's use.

It is a further object of the invention in an embodiment of the invention to provide a plant cover that is convenient for gardeners to use.

These and other objects and advantages of the invention will be clear in view of the following description to the invention including the associated drawings.

### BRIEF DESCRIPTION OF THE DRAWINGS

The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. All Figures are drawn for ease of explanation of the basic teachings of the present invention only; the extensions of the Figures with respect to number, position, relationship, and dimensions of the parts to form the preferred embodiment will be explained or will be within the skill of the art after the following description has been read and understood. Further, the exact dimensions and dimensional proportions to conform to specific force, weight, strength and similar requirements will likewise be within the skill of the art after the following description has been read and understood.

FIG. 1 is a perspective view of the invention.

FIG. 2 is an end view of the invention.

FIG. 3 is a top view of the invention.

FIG. 4 is a plan view of a clip used in one embodiment of the invention.

FIG. 5 is a perspective view of the end piece of the invention in one embodiment of the invention in the process of being connected to the main body.

FIG. 6 is a perspective view of the end piece of the invention in another embodiment of the invention in the process of being connected to the main body.

FIG. 7 is a perspective view of the invention in a rolled up and easily transportable configuration.

### DETAILED DESCRIPTION OF THE INVENTION

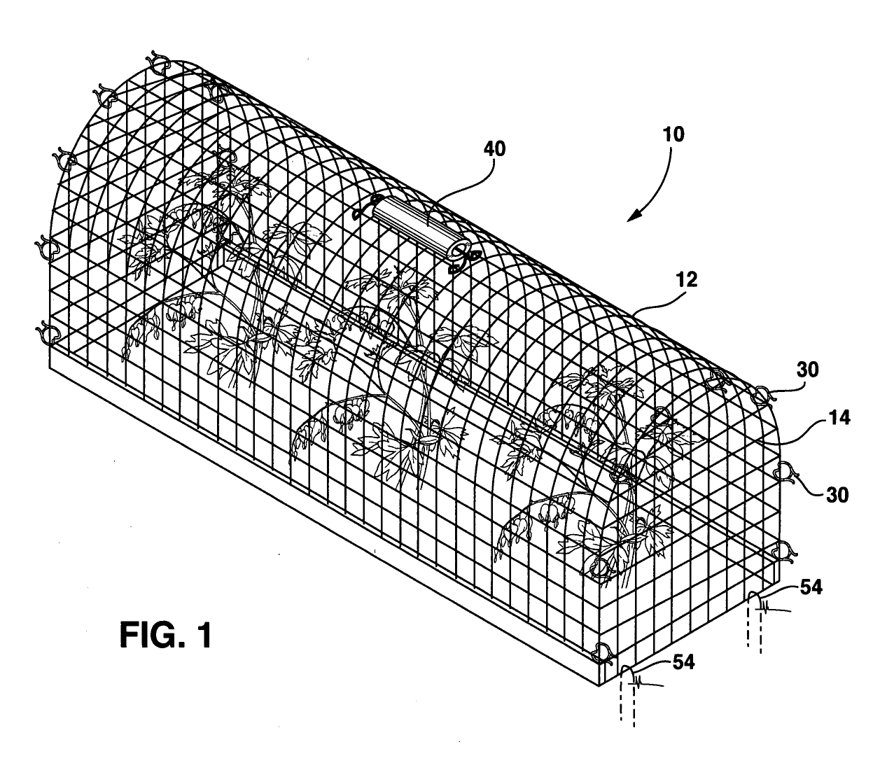

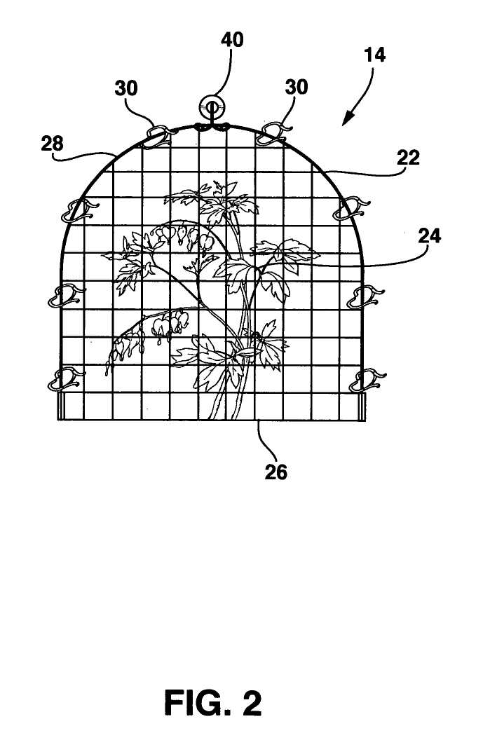

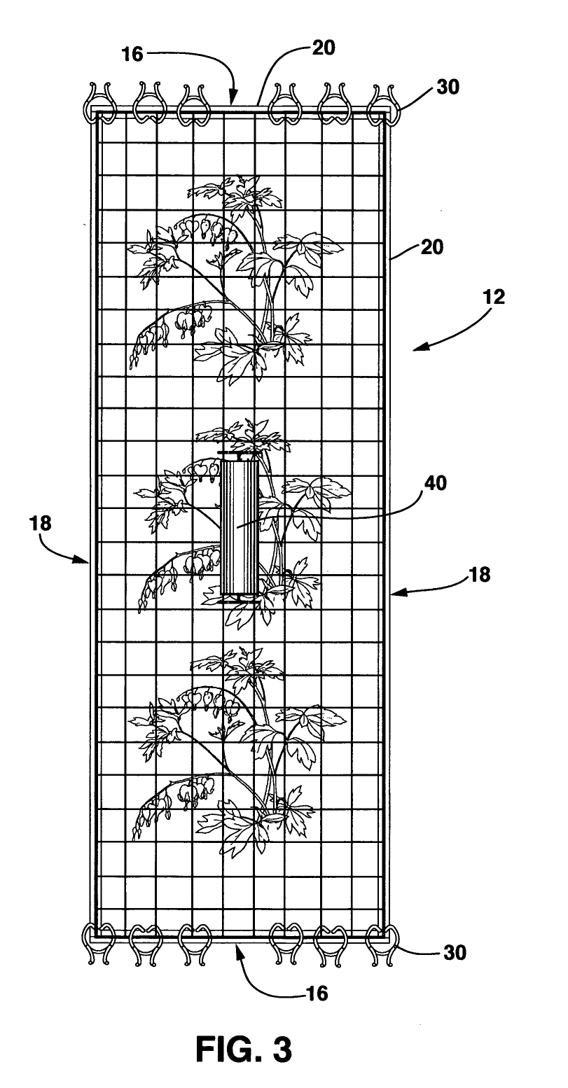

The plant cover of the present invention is shown in FIGS. 1-7 generally labeled 10. The plant cover 10, in the preferred embodiment shown in FIGS. 1-5, has a main body 12 and a pair of end pieces 14.

Main body 12 is preferably made of a rectangular piece of screen, wire mesh or netting having opposed attachment ends 16 and parallel lengthwise ends 18. The function of main body 12 is to provide a protective barrier for the plants of the garden or garden area from animal or insect pests while at the same time allowing water, air or sunlight or all of these to pass through the main body 12 for the benefit of the plant or plants being protected. It is desirable for main body 12 to be spaced a distance away from the plant or plants to be protected to allow room for the plant or plants to grow and to prevent access to the plant or plants through the main body 12 by the animal or insect pests. Consequently, main body 12 must be of a sufficient size to cover the garden or desired garden area and provide the spacing between the main body 12 and the plants. It is clear that main body 12 may be made in a variety of sizes to accommodate a variety of needs.

In the preferred embodiment shown in FIGS. 1-6, the main body 12 is made of a rectangular piece of screen, wire mesh or netting. The rectangular piece of screen, wire mesh or netting of main body 12 preferably has an edge piece 20 that extends around at least a portion of the periphery of the rectangular piece of screen, wire mesh or netting including the attachment ends 16 and lengthwise ends 18. Edge piece 20 may extend entirely around the entire periphery of the main body 12 or may only extend around a portion of it. For example, the edge piece 20 could include the lengthwise ends 18 but not be present for the attachment ends 16. Or, the edge piece 20 could include the attachment ends 16 but not be present for the lengthwise ends 18.

The function of edge piece 20 is to protect the outer edges of the screen, wire mesh or netting and also, in the embodiment where the edge piece 20 extends around the attachment ends 16, to provide a well defined edge on attachments ends 16 to be connected with the end pieces 14 and, along the lengthwise ends 18, contact the ground of the garden or garden area that the plant cover 10 is protecting. This edge piece 20 is preferably made of a flexible material such as plastic that is formed around the outer edge of the main body 12 but could also be any material that allows the main body 12 to be formed into a roughly cylindrical shape and provide the function described above for edge piece 20 or could be the material of the main body 12 itself folded back on, crimped or otherwise folded or formed into a distinctive edge. In addition, the edge piece 20 could be weighted to better hold the plant cover 10 in contact with the ground and to make the plant cover 10 less susceptible to being blown away by the wind.

The screen, wire mesh or netting of main body 12 is preferably made of a wire material such as galvanized steel, metal or plastic screen, chicken wire or poultry netting. While the screen, wire mesh or netting of main body 12 is preferably made of a wire material, the screen, wire mesh or netting of main body 12 may also be made of any material that allows main body 12 to be formed into a shape that covers and protects the plant or plants to be protected and allows water, air or sunlight or all of these to pass through the main body 12 for the benefit of the plant or plants being protected.

The holes in the screen, wire mesh or netting of main body 12 are of such a size as to prevent passage through the holes by the animal or insect pest. However, the holes in the screen, wire mesh or netting allow water, air and sunlight or all of these to pass through the main body 12 to reach the plants of the garden or garden area that plant cover 10 is protecting. For example, and without intending to limit the characteristics of the screen, wire mesh or netting, holes in the screen, wire mesh or netting having diameters of from about 1/16 inch to about 15/16 inch are most desirable. Further, the shape of the holes maybe any shape including, but not limited to, round, oval, elliptical, square, rectangular, triangular or other geometric shaped holes, free form holes or holes in the form of particular shapes such as animals, states, icons and symbols.

In the preferred embodiment of the plant cover 10, there are a pair of end pieces 14 that are connected to the main body 12 and provide structural support for the main body 12. In the preferred embodiment, each end pieces 14 has an outer frame 22 that defines the shape of the end pieces 14 and a screen piece 24 that extends across the end piece 14 between the portions of the outer frame 22. Also in the preferred embodiment, the end pieces 14 are substantially planar. But, end pieces 14 may also be non-planar.

The outer frame 22 is preferable made of a material that can be formed into and holds a predetermined shape. Consequently, the outer frame 22 is preferable made of any rigid or semi rigid material such as plastic, metal or wood. The material of the screen pieces 24 may be attached to the outer frame 22 by any conventional means such as adhesives, screws, nails, being molded into the material of the outer frame 22 or mechanically held in place by clamps, catches, or rivets as would be well understood by those skilled in the art. In addition, all or part of the outer frame 22 could be weighted to better hold the plant cover 10 in contact with the ground and to make the plant cover 10 less susceptible to being blown away by the wind.

Each outer frame 22 has a flat side 26 that is intended to be in contact with the ground of the garden or garden area to be protected by plant cover 10. In addition, each outer frame 22 has a attachment edge 28 that extends from each end of flat side 26. The shape of attachment edge 28 in combination with the main body 12 will define the shape of the plant cover 10 as described hereafter.

As mentioned above, the preferred shape of end pieces 14 is planar. In this configuration, flat side 26 will also be essentially a straight line. However, end pieces 14 may also be non-planar. In this configuration, while flat side 26 is constrained to be contained in a plane (e.g., the plane of the ground of the garden or garden area plant cover 10 is covering) flat side 26 need not be a straight line. Instead, flat side 26 could take on a variety of curved or other non-straight shapes such as, but not limited to, semi-circular, elliptical, hyperbolic, parabolic, trapezoidal or triangular.

One preferred shape for the attachment edge 28 is partially circular so that the attachment edge 28 between the ends of flat side 26 is semi-circular or partially circular. As another example of the shape of attachment edge 28, attachment edge 28 may be elliptical. Another variant of the shape of attachment edge 28 is for attachment edge 28 to extend upward from the ends of flat side 26 in a parallel direction for a distance whereafter the parallel pieces are connected by a semicircular, elliptical, hyperbolic, parabolic, trapezoidal, rectangular, square, triangular or straight piece. Further variants of the shape of attachment edge 28 include, but are not limited to, hyperbolic, parabolic, trapezoidal, rectangular, square or triangular.

In the latter configuration, the resulting shape of the plant cover 10 will be the surface of a geometric solid. Other examples will occur to those skilled in the art. The function of the shape of attachment edge 28 is to define a final shape for main body 12 that provides a covering over the plant or plants to be protected by plant cover 10 where the main body 12 is spaced away from the plant or plants.

Outer frame 22 may extend entirely around the periphery of the end piece 14 or may only extend around a portion of it. For example, the outer frame 22 could include the attachment edge 28 but not be present for the flat side 26. In the embodiment where the outer frame 22 is not present along the flat side 26, outer frame 22 may have to be fairly rigid to define the shape of the end piece 14.

The screen piece 24 is preferably also made of a wire material such as galvanized steel, metal or plastic screen, chicken wire or poultry netting. While the screen, wire mesh or netting of screen piece 24 is preferably made of a wire material, the screen, wire mesh or netting of screen piece 24 may also be made of any material that is placed between the edges of the outer frame 22 and protects the plant or plants to be protected from the animal or insect pest. In addition, it is desirable, but not essential, that the material of screen piece 24 allow water, air or sunlight or all of these to pass through the screen piece 24 for the benefit of the plant or plants being protected. As a result, the screen piece 24 could be made of a material not having holes such as a solid piece of plastic or could be molded or formed together with the outer frame 22.

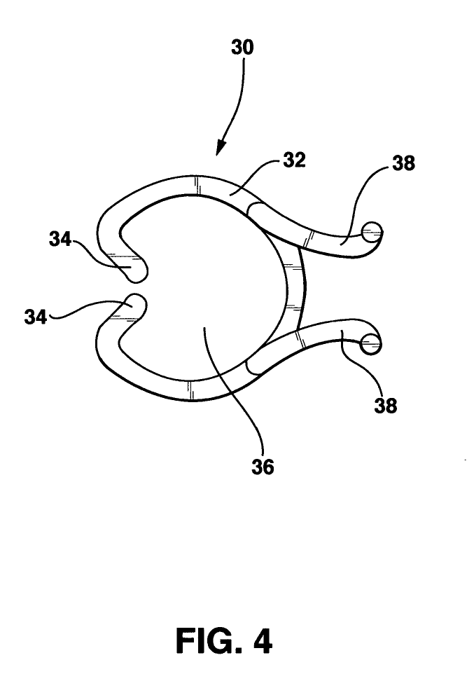

In the embodiment of the plant cover 10 shown in FIGS. 1-5, a clip 30 (FIG. 4) is used to connect the main body 12 to the end pieces 14. The clip 30 has a main body 32 with opposed ends 34 and a central space 36. The shape of main body 32 is roughly circular defining the central space 36 although main body 32 could be other shapes including oval, elongated, elliptical, square, rectangular or an almost infinite variety of other shapes that provide a defined outer surface with an open end at the opposed ends 34 and that holds the opposed ends 34 in near proximity to each other.

Each opposed end 34 preferably turns toward the central space 36 of main body 32 at the ultimate end of opposed ends 34. Also, clip 30 preferably has a pair of gripping arms 38 that extend outwardly from the main body 32 opposite the opposed ends 34. These gripping arms 38 allow the user to more easily grasp the clip 30 while the clip 30 is being used to connect the main body 12 to the end pieces 14 as will be described hereafter.

The plant cover 10 also preferably includes a handle 40 that is attached to main body 12 in such a way as to easily allow the user to lift the plant cover 10 to place the plant cover 10 in position over the garden or garden area to be protected or to lift the plant cover 10 from the garden or garden area to allow access to the plants protected by the plant cover 10. Handle 40 may be any of an unlimited variety of handles that allow the user to grasp the handle 40 and lift the plant cover 10. Handle 40 is attached to main body 12 by any well-known means including but not limited to nuts and bolts, adhesives, welding, mechanical contact, molding or any other means there will occur to those skilled in the art.

To assemble the plant cover 10, the main body 12 is laid out on a flat surface. To aid in assembling the plant cover 10, it may be desirable to form the main body 12 into a substantially cylindrical shape. An end piece 14 is brought near one end of the main body 12. A clip 30 is brought into contact with the attachment edge 28 of the outer edge 16 of the end piece 14 so that the attachment edge 28 passes between being opposed ends 34 and into the space within the main body 32. Thereafter, the edge piece 20 of the main body 12 is also brought to pass between the opposed ends 34 and into the central space 36 within the main body 32. The inward curve of the opposed ends 34 aids in preventing the edge piece 20 or the attachment edge 28 from passing back past the opposed ends 34. In the preferred embodiment, both the main body 12 and the screen piece 24 are made of wire, screen or mesh. The clip 30 is located on both the main body 12 and the end piece 14 between successive sections of such wire, screen or mesh. In this way the clip 30 binds the edge piece 20 of the main body 12 to the attachment edge 28 of the end piece 14 while at the same time prevents the main body 12 from moving relative to the end piece 14 by the constraint of the successive sections of the wire, screen or mesh of the main body 12 and end piece 14.

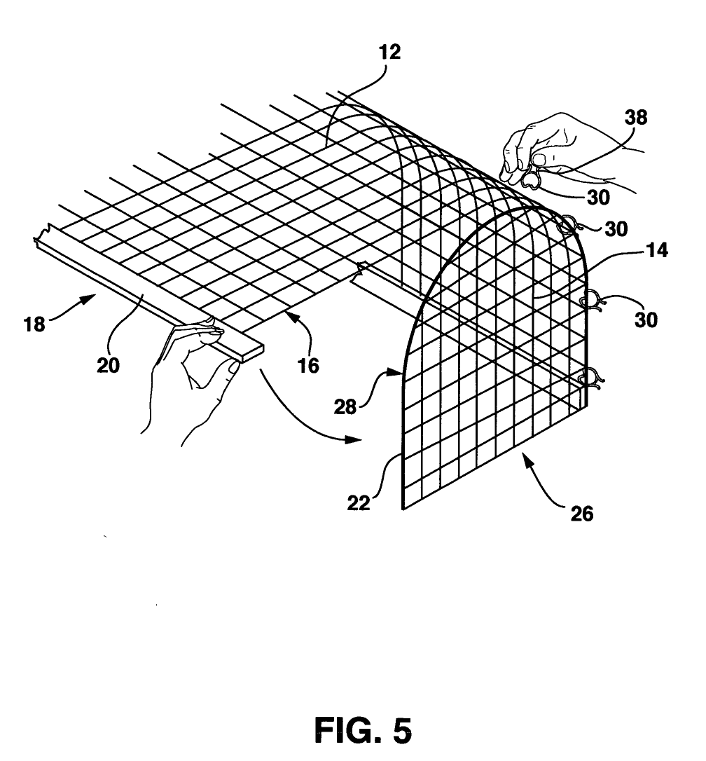

A series of such clips 30 is than placed around the periphery of the outer edge 16 to connect the edge piece 20 of the main body 12 to the attachment edge 28 of the end pieces 14. As a result, the main body 12 takes on a structural shape determined by the shape of the end piece 14. As shown in FIG. 5, the gripping arms 38 of the clip 30 allow the user to grasp the clip 30 to enable the placement of the clips 30 as described above.

It is clear that the order that the main body 12 and end pieces 14 are brought into contact with clips 30 is not essential. The edge piece 20 of the main body 12 may be passed through the space between the opposed ends 34 of clip 30 and into the central space 36 first followed by the attachment edge 28 of the end piece 14 or the edge piece 20 of the main body 12 and the attachment edge 28 of the end pieces 14 may simultaneously be brought through the space between the opposed ends 34 of clip 30 into the central space 36 of the main body 32. This procedure is repeated for the end piece 14 on the opposite end of the plant cover 10. In this way, the plant cover 10 takes on a defined rigid structural shape.

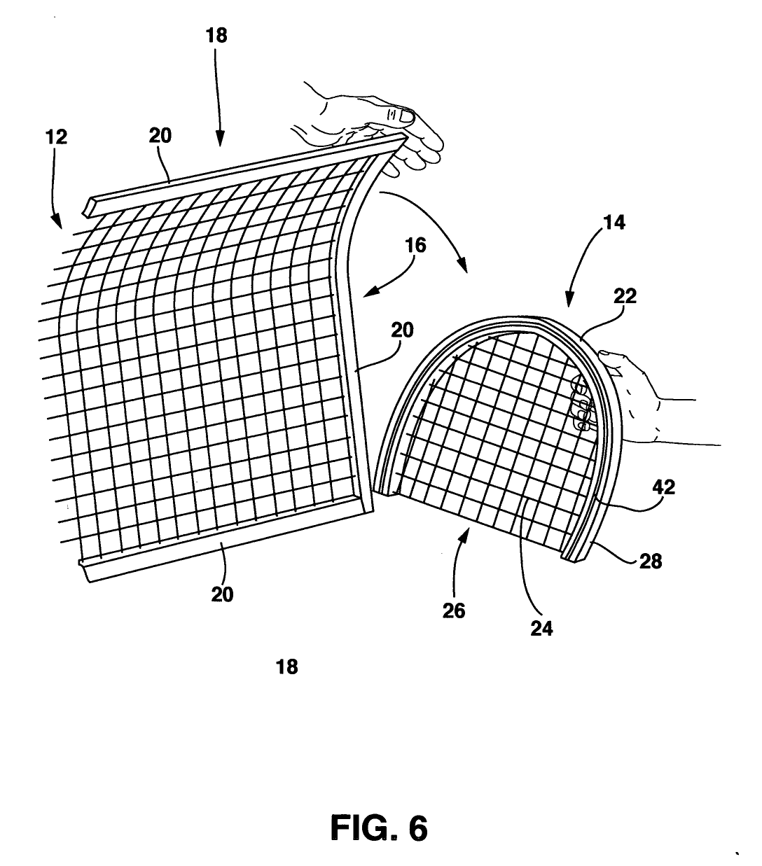

In an alternate embodiment of the plant cover 10 shown in FIG. 6, the outer frame 22 has a slot 42 sized and adapted to receive and hold, by mechanical or frictional contact, the edge piece 20 of main body 12 that comes in contact with the attachment edge 28 of the outer frame 22. In this embodiment, to assemble the plant cover 10, the main body 12 is unrolled and laid flat. Again, it may be desirable to form the main body 12 into a substantially cylindrical shape. The edge pieces 16 of main body 12 are brought into contact with the slot 42 of the attachment edge 28 of the outer frame 22. The edge pieces 16 are then forced into the slot 42 where mechanical contact or frictional contact between the edge pieces 16 in the slot 42 securely hold the edge pieces 16 in a defined position with respect to the outer piece 16. As a result, the shape of the outer piece 16 defines the shape of the main body 12 in the functional configuration of the plant cover 10.

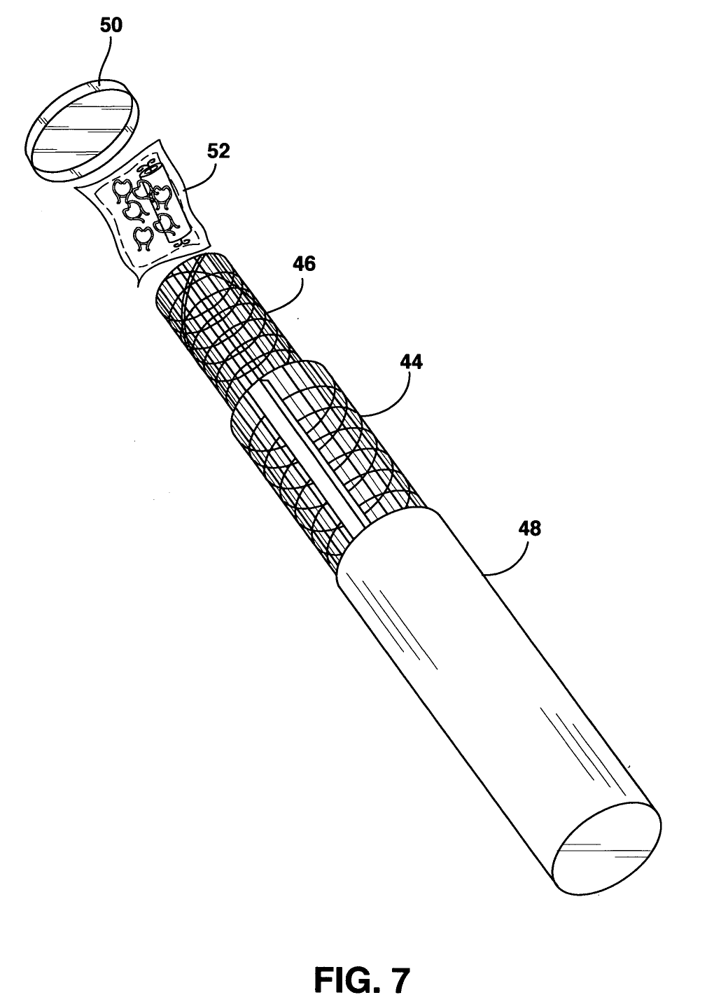

In any preferred embodiment of the plant cover 10, it desirable but not essential that the plant cover 10 be made compact for storage or transportation as shown in FIG. 7. This is preferably accomplished by rolling up the main body 12 into a compact main body cylinder 44. In addition, if the material of the end pieces 14, particularly the material of the outer frame 22 and screen piece 24, are sufficiently flexible, the end pieces 14 may also be rolled into a compact end piece cylinder 46. Both the compact main body cylinder 44 of the main body 12 and the compact end piece cylinder 46 of the end pieces 14 may be placed in a container 48 for storage or transportation. Container 48 may include an end cap 50 to close the container 48 and may also include instructions 52. Container 48 may be a flexible bag or a rigid tube.

Alternately or in addition, the main body 12 may be maintained in the compact main body cylinder 44 by placing a band around the rolled up main body 12 to prevent main body 12 from unrolling. Likewise, the end piece 14 may be maintained in the compact end piece cylinder 44 by placing a band around the rolled up end pieces 14 to prevent end pieces 14 from unrolling.

In another alternate embodiment, the end pieces 24 may be attached to compact main body cylinder 44 by means such as plastic ties, rubber bands, shrink wrap and wire ties. Although there has been described various ways of maintaining the main body 12 in a compact cylindrical shape and for attaching main body 12 in this configuration to the end pieces 14, an almost limitless number ways of achieving these multiple objectives will be envisioned by those skilled in the art and are intended to be incorporated into this invention.

In use, once the plant cover 10 has been assembled, the plant cover 10 is lifted by the handle 40 over the plant or plants to be protected by plant cover 10 and settled over the plant or plants. The edge piece 20 of main body 12 and flat sides 20 of end pieces 14 will come in contact with the ground of the garden or garden area. There should be very little space between the edge piece 20 of main body 12 and flat sides 20 of end pieces 14 and the ground of the garden area to prevent the unwanted animal past from having access to the plant or plants to be protected by simply going under the edge piece 20 or flat sides 20.

With the plant cover 10 in this position, the unwanted animal tests are prohibited from contact with the plant or plants to be protected by the plant cover 10. When it is desired to move the plant cover 10, for example to have access to the plant or plants to harvest, feed, water, fertilize, or otherwise have interaction with the plant or plants, the plant cover 10 is easily removed by grasping the handle 40 and lifting the plant cover 10 away from the plant or plants. Plant cover 10 may be set aside while access is gained to the plant or plants whereafter the plant cover 10 is grasped by the handle 40 and replaced over the plant or plants to be protected.

In one embodiment of the plant cover 10, the plant cover 10 is used for one season and then discarded whereupon a new plant cover 10 is purchased to be used for the next season. In this embodiment of plant cover 10, the materials comprising the main body 12 and end pieces 14 are made of relatively inexpensive material. In another embodiment of plant cover 10, the plant cover 10 is intended to be used for multiple seasons. In order to be used for multiple seasons, the materials of plant cover 10 in this embodiment would need to be more durable than those used in the disposable embodiment discussed above.

Also, in most locations, this reusable embodiment of the plant cover 10 will require that the plant cover 10 be stored from one season to the next. It is most desirable that in this configuration the plant cover 10 can be disassembled so that the main body 12 is separated from the end pieces 14. The main body 12 may then be rolled into a compact cylindrical configuration described above, perhaps connected to the end pieces 14, and then stored as a unit to be reassembled as described above for use in the next season.

The invention described above is primarily intended and is useful for protecting a garden or garden area from an animal or insect pest. However, the plant cover 10 as described herein is not required to be exclusively used in gardens. The plant cover 10 as described herein may also be used in lawns, patios and decks for plant protection.

The present invention has been described in connection with certain embodiments, configurations and relative dimensions. However, description above is not to be construed as being absolutely particular. It is to be understood that the description given herein has been given for the purpose of explaining and illustrating the invention and are not intended to limit the scope of the invention. For example, additional methods of attaching the end pieces 14 to the main body 12 could be implemented in the present invention and still be within the scope of the invention.

Further, as described above, the preferred embodiment of the main body 12 is for it to be substantially cylindrical when assembled. This means that main body 12 has the shape of a cylinder intersected by a plane wherein the plane is the plane of the ground that the plant cover 12 is placed on. This configuration of main body 12 is particularly ideally adapted for the plant cover 10 because of the simplicity of manufacturing, transporting, storing and assembling plant cover 10 by connecting main body 12 to end pieces 14.

But, main body 12 could be any other shape so long as the main body 12 is spaced a distance away from the plant or plants to be protected to allow room for the plant or plants to grow and to prevent access to the plant or plants through the main body 12 by the animal or insect pests. Without intending to limit the possible configurations of the main body 12, examples of shapes for the main body 12 include the surface of solid geometric shapes or such shapes intersected by a plane (e.g., the plane of the ground) extending through such solid geometric shapes including, but not limited to, a cylinder substantially as described above with a flat top, a trapezoidal cubic form, rectangular prism, pyramid, cube, sphere, spheroid, ellipse or ellipsoid semi-ellipsoid elliptical solid, elliptical cylinder or stadium plat or a portion (e.g. half) thereof of any of these shapes.

Further, the plant cover 10 could have the main body 12 and end pieces 14 integrally formed of a single material. In addition, the plant cover 10 could have a stake 54 (FIG. 1) that anchors the plant cover 10 to the ground to better hold the plant cover 10 in contact with the ground and to make the plant cover 10 less susceptible to being blown away by the wind. Stake 54 could be a loop of metal or wire or stake like a tent stake that hooks onto or over part of the screen, wire mesh or netting of main body 12 or the screen, wire mesh or netting of end pieces 14.

There are many materials and configurations that can be used in constructing the invention by those skilled in the art including all types of screens and wire meshes. In addition, it is clear than an almost infinite number of minor variations to the form and function of the disclosed invention could be made and also still be within the scope of the invention. Consequently, it is not intended that the invention be limited to the specific embodiments and variants of the invention disclosed. It is to be further understood that changes and modifications to the descriptions given herein will occur to those skilled in the art. Therefore, the scope of the invention should be limited only by the scope of the claims.

I claim:

1. A plant cover for protecting a garden or garden area from animal or insect pests comprising:
a main body having opposed ends, the main body being made of a material to provide a protective barrier for the plants of the garden or garden area from animal or insect pests while at the same time allowing water, air or sunlight to pass through the main body for the benefit of the plant or plants being protected, wherein the main body is spaced a distance away from the plant or plants to be protected;
a pair of end pieces that are connected to opposed ends of the main body and provide structural support for and define the shape of the main body.

2. The plant cover of claim 1 wherein the material of the main body is screen, wire mesh or netting.

3. The plant cover of claim 2 wherein the screen, wire mesh or netting of main body is made of a material chosen from the group consisting of galvanized steel, metal or plastic screen, chicken wire or poultry netting.

4. The plant cover of claim 2 wherein the screen, wire mesh or netting of the main body have holes of such a size as to prevent passage through the holes by animal or insect pests but allow water, air or sunlight to pass through the main body to reach the plants of the garden or garden area that plant cover is protecting.

5. The plant cover of claim 1 wherein the main body has an edge piece that extends around at least a portion of the periphery of the main body.

6. The plant cover of claim 5 wherein the edge piece is formed around the outer edge of the main body.

7. The plant cover of claim 5 wherein at least a part of the edge piece is weighted.

8. The plant cover of claim 1 wherein the main body is substantially cylindrical in shape.

9. The plant cover of claim 1 wherein each end piece has an outer frame that defines the shape of the end pieces and a screen piece that extends across the end piece between portions of the outer frame.

10. The plant cover of claim 9 wherein at least a portion of the outer frame is made of a material that can be formed into and hold a predetermined shape.

11. The plant cover of claim 9 wherein at least a portion of the outer frame is weighted.

12. The plant cover of claim 9 wherein each outer frame has a flat side that contacts ground of a garden or garden area to be protected by the plant cover wherein each flat side has opposed ends.

13. The plant cover of claim 12 wherein each outer frame has an attachment edge that extends from each end of a flat side that in combination with the main body defines the shape of the plant cover.

14. The plant cover of claim 9 wherein the material of the screen piece allows water, air or sunlight to pass through the screen piece for the benefit of the plant or plants being protected.

15. The plant cover of claim 14 wherein the screen piece is made of a wire material chosen from the group consisting of galvanized steel, metal or plastic screen, chicken wire or poultry netting.

16. The plant cover of claim 9 wherein the screen piece is made of a material not having holes.

17. The plant cover of claim 9 wherein the outer frame has a slot sized and adapted to receive and hold, by mechanical or frictional contact, the opposed ends of the main body.

18. The plant cover of claim 1 further comprising a clip connecting the main body to the end pieces.

19. The plant cover of claim 1 further comprising means to connect the main body to the end pieces wherein the means are chosen from a group consisting of as plastic ties, rubber bands, shrink wrap and wire ties.

20. The plant cover of claim 1 further comprising a handle that is attached to main body in such a way as to easily allow the user to lift the plant cover to place the plant cover in position over the garden or garden area to be protected or to lift the plant cover from the garden or garden area to allow access to the plants protected by the plant cover.

21. The plant cover of claim 1 further comprising a container for storage or transportation of the plant cover and wherein the main body is rolled up into a compact main body cylinder that is placed in the container.

22. The plant cover of claim 22 wherein the end pieces are rolled into a compact end piece cylinder that is placed in the container.

23. A plant cover for protecting a garden or garden area from animal or insect pests comprising:
a main body having opposed ends, the main body being made of a material to provide a protective barrier for the plants of the garden or garden area from animal or insect pests while at the same time allowing water, air or sunlight to pass through the main body for the benefit of the plant or plants being protected, wherein the main body is spaced a distance away from the plant or plants to be protected, wherein the material of the main body is screen, wire mesh or netting, and wherein the main body has an edge piece that extends around at least a portion of the periphery of the main body;
a pair of end pieces that are connected to opposed ends of the main body and provide structural support for and define the shape of the main body, wherein each end piece has an outer frame that defines the shape of the end pieces and a screen piece that extends across the end piece between portions of the outer frame and wherein at least a portion of the outer frame is made of a material that can be formed into and hold a predetermined shape.

24. A plant cover for protecting a garden or garden area from animal or insect pests comprising:
a main body having opposed ends, the main body being made of a material to provide a protective barrier for the plants of the garden or garden area from animal or insect pests while at the same time allowing water, air or sunlight to pass through the main body for the benefit of the plant or plants being protected, wherein the main body is spaced a distance away from the plant or plants to be protected, wherein the material of the main body is screen, wire mesh or netting, and wherein the main body has an edge piece that extends around at least a portion of the periphery of the main body;
a pair of end pieces that are connected to opposed ends of the main body and provide structural support for and define the shape of the main body, wherein each end piece has an outer frame that defines the shape of the end pieces and a screen piece that extends across the end piece between portions of the outer frame and wherein at least a portion of the outer frame is made of a material that can be formed into and hold a predetermined shape and wherein at least a portion of the outer frame is weighted and wherein each outer frame has a flat side that contacts ground of a garden or garden area to be protected by the plant cover wherein each flat side has opposed ends and wherein each outer frame has an attachment edge that extends from each end of a flat side that in combination with the main body defines the shape of the plant cover;
wherein the main body is attached to the end pieces by means selected from the group consisting of a clip or mechanical or frictional contact between the opposed ends of the main body and a slot formed in the outer frame of the edge pieces.
